(19) United States
(12) Patent Application Publication
(10) Pub. No.: US 2025/0378136 A1
(43) Pub. Date: Dec. 11, 2025

(54) DETECTING SUBTLE CONSUMER PREFERENCES WITH GRANULAR BROWSING BEHAVIORS ON CONSOLE/APP

(71) Applicant: Sony Interactive Entertainment Inc., Tokyo (JP)

(72) Inventor: Chen Yao, San Mateo, CA (US)

(21) Appl. No.: 18/739,034

(22) Filed: Jun. 10, 2024

(51) Int. Cl. G06F 17/40; G06F 3/0354

(52) U.S. Cl. CPC G06F 17/40; G06F 3/03547

(57) ABSTRACT

Personalized experiences for a user are based on the input patterns of the user. Scrolling behavior on a touchscreen may be used to deliver personalized experiences. The point-by-point coarse scrolling data is aggregated and condensed on the user device being scrolled and the condensed data sent to a server for analysis to save bandwidth.

### FIELD

The present application relates generally to detecting subtle consumer preferences with granular browsing behaviors on console/app.

### BACKGROUND

Detecting and understanding player preferences on digital surfaces such as console screens and application (“app”) screens is challenging due to the dynamic nature and the fact that preferences are not always explicitly expressed through clicks or interactions. As understood herein, most signals used to assess user preferences are explicit interaction events, which are too coarse and do not capture the nuances of user behavior.

### SUMMARY

Present principles, in recognizing the above technical challenges, provide personalized experiences for a user based on capturing and deriving more granular signals that can accurately reflect user preferences, such as scrolling patterns (speed, frequency, and direction changes), impression patterns (pause duration and frequency), and trends in these patterns over time. These signals provide valuable insights into how users are responding to the content they are presented with. However, as understood herein, capturing, sending, and storing all the raw data needed to calculate these signals can be costly and challenging, especially in scenarios where interactions occur on the edge (e.g., consoles, PCs, mobile devices). To address this, a two-stage technique is provided in which the raw scrolling data is aggregated locally on the device where the interactions occur. This reduces the amount of data that must be sent to the cloud and helps to minimize costs since not send all raw data points are sent to the cloud, but only condensed representations thereof, such as vectors. Then cloud modeling is used on the condensed aggregated results which are sent to the cloud for further modeling and analysis to leverage the scalability and processing power of the cloud to derive more accurate and detailed insights into user preferences. By capturing and analyzing these granular signals, a better understanding of player preferences is gained and more dynamic and personalized experiences are delivered to the user.

Accordingly, a method includes receiving raw data from touch input on a touch surface of a device, and at the device, condensing the raw data to condensed data. The method also includes sending the condensed data to an analysis apparatus. The method includes, at the analysis apparatus, using the condensed data to identify personalization information, sending the personalization information to the device, and implementing at least some of the personalization information on the device.

The raw data may be from a scroll motion on the touch surface. In example embodiments, the condensed data includes at least one vector indicating direction and speed of the scroll motion. Also, in some examples the condensed data may include at least an identification of content being presented concurrently with receiving the raw data from the touch surface.

In example implementations, the device can include a computer game controller or a wireless telephone. In some embodiments the analysis apparatus can include a cloud server.

If desired, the method may include inputting the condensed data to at least one machine learning (ML) model, and receiving the personalization information from the ML model.

In an example embodiment, the raw data includes a series of x/y coordinates.

In another aspect, a processor system is configured to receive signals from a touch surface of a device, and condense the signals to vectors. The processor system also is configured to send the vectors to an analysis apparatus. The processor system is further configured to receive from the analysis apparatus personalization information related to the vectors, and implement the personalization information on the device.

In another aspect, an apparatus includes at least one computer memory that is not a transitory signal and that in turn includes instructions executable by at least one processor system to receive condensed data from a device. The condensed data represents raw data generated by a scroll motion on a touch surface of the device. The instructions are executable to correlate the condensed data to personalization information, and transmit the personalization information to the device.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example system with which present techniques may be used;

FIG. 3 illustrates an example input device consistent with present principles;

FIG. 4 illustrates an example overall logic in example flow chart format;

FIG. 5 illustrates a first example mapping of raw scrolling data to a condensed representation thereof;

FIG. 6 illustrates a second example mapping of raw scrolling data to a condensed representation thereof;

FIG. 7 illustrates a third example mapping of raw scrolling data to a condensed representation thereof;

FIG. 8 illustrates an example machine learning (ML) training logic in example flow chart format;

FIG. 9 illustrates an example ML model use logic in example flow chart format;

FIG. 10 illustrates example weighting logic in example flow chart format;

FIG. 11 illustrates an example screen shot consistent with present principles;

FIG. 12 illustrates example learning of normalization logic in example flow chart format;

FIG. 13 illustrates example logic for use of learned normalization consistent with FIG. 12;

FIG. 14 illustrates further example logic for use of normalization;

FIG. 15 illustrates further example logic for use of normalization;

FIG. 16 illustrates a first example screen shot consistent with FIG. 15; and

FIG. 17 illustrates a second example screen shot consistent with FIG. 15.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

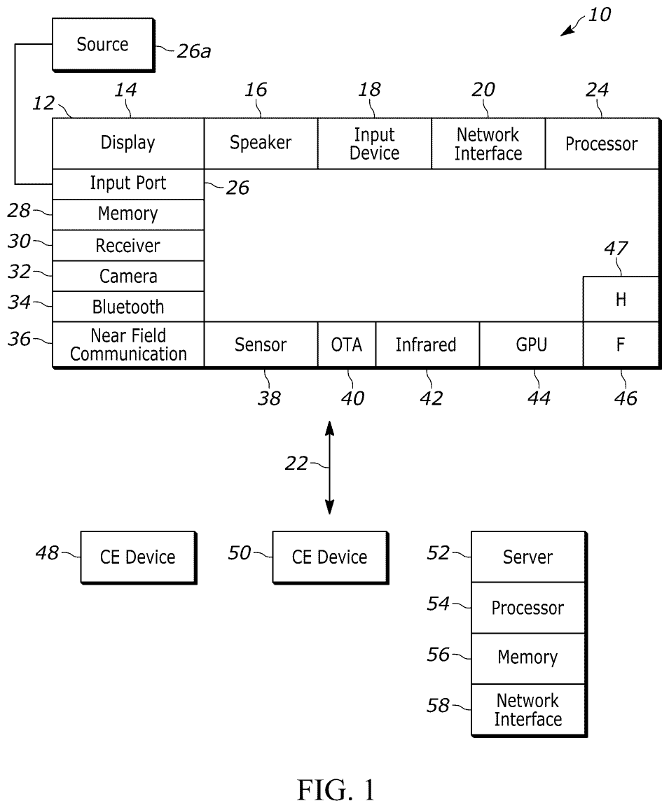

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

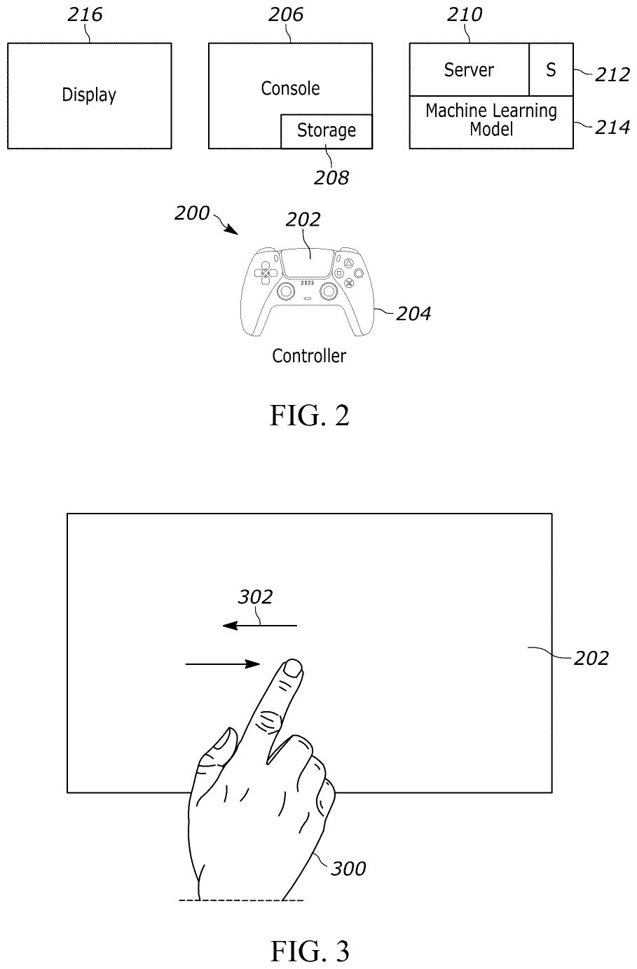

Refer now to FIG. 2. A computer simulation controller 200 such as a computer game controller made by Sony may be wielded by a player to play a computer simulation such as a computer game. The controller 200 includes, in addition to input buttons and joysticks, a touch screen or touch pad 202, and contains local storage 204 (shown schematically in FIG. 2) for storing raw touch signals from the touch screen or touch pad 202. The touch screen or pad 202 may use capacitive and/or resistive touch sensing technology, and raw data from touches of the screen or pad 202 may be stored in the storage 204. A processor system (not shown) such as any processor or processors described in FIG. 1 may be provided in the controller 200 to process the raw data in the storage 204 as described herein. The raw data typically includes a sequence of x/y coordinates indicating the location of touches, such as swipes, that may be associated with times of touch. Raw data in the form of a time-stamped sequence of x/y coordinates thus collectively may define a direction and speed of scrolling, for example.

The controller 200 with touch screen or pad 202 is but one example of an input device with a touch sensitive surface to which present techniques may be applied. Other examples include laptop computers and other computers as well as wireless telephones.

The controller 200 may be used to control a computer game sourced by a computer game console 206 with storage 208. A cloud-based server 210 with storage 212 also may be used to stream a computer game. A processor system (not shown) such as any processor or processors described in FIG. 1 may be provided in the server 210 to process data from the touch screen or pad 202 sent via wired and/or wireless paths from the controller 200. Server processing may be effected using one or more machine learning (ML) models 214 as described herein. The computer game may be presented on a display 216.

FIG. 3 illustrates a user or player 300 scrolling on the touch screen or pad 202. Arrows 302 indicate that the user may scroll left and right or up and down or indeed in any direction on the screen or pad 202.

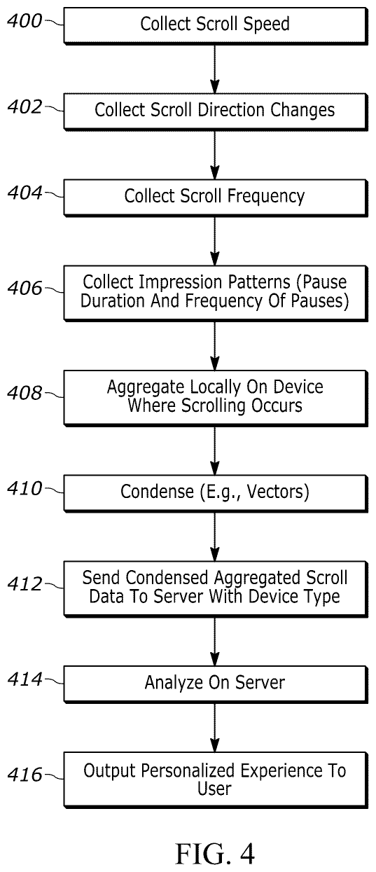

FIG. 4 illustrates example overall logic. Commencing at state 400, raw data from the touch pad 202 is collected which in the aggregate may indicate speed of scrolling. Also, as indicated at state 402 raw data from the touch pad 202 is collected which in the aggregate may indicate changes in the direction of scrolling. Further, as indicated at state 404 raw data from the touch pad 202 is collected which in the aggregate may indicate the frequency the user starts new scrolling. Further, as indicated at state 406 raw data from the touch pad 202 is collected which in the aggregate may indicate impression patterns as may be implied from pauses in scrolling and duration of pauses and frequency of pauses. As the raw data from touch is collected, the identification of whatever underlying content is concurrently being presented on the display 216 (game scene, advertisements, movie trailers, etc.) is collected and associated with the concurrently-generated raw touch data.

Present principles, in recognizing technical challenges discussed herein, provide personalized experiences for a user based on capturing and deriving more granular signals from raw touch pad data that can accurately reflect user preferences, such as scrolling patterns (speed, frequency, and direction changes), impression patterns (pause duration and frequency), and trends in these patterns over time. These signals provide valuable insights into how users are responding to the content they are presented with. However, as understood herein, capturing, sending, and storing all the raw data needed to calculate these signals can be costly and challenging, especially in scenarios where interactions occur on the edge (e.g., consoles, PCs, mobile devices). To address this, a two-stage technique is provided in which the raw scrolling data from states 400-406 is aggregated at state 408 locally on the device where the interactions occur. The information indicated by the raw data is condensed at state 410 to reduce the amount of data sent at state 412 to the cloud server 210 for analysis of the condensed data by the server at state 414. Thus, costs are minimized since not all raw data points are sent to the cloud, but only condensed representations thereof, such as vectors. Then at state 416 cloud modeling is used on the condensed aggregated results which are sent to the cloud for further modeling and analysis to leverage the scalability and processing power of the cloud to derive more accurate and detailed insights into user preferences. By capturing and analyzing these granular signals, a better understanding of player preferences is gained and more dynamic and personalized experiences are delivered to the user.

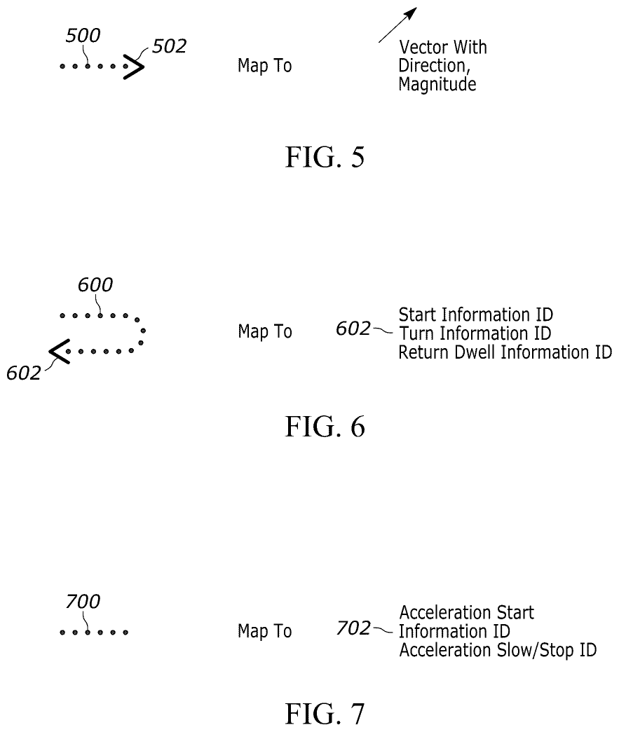

FIG. 5 illustrates a series 500 of x/y coordinates along a line generated by a scroll from left to right as indicated by the arrow 502. The raw data 500 is condensed at the device on which the scroll was input into a vector 504 the length of which indicates the speed of scroll and the direction of which indicates the direction of scroll. Only the length and direction of the vector need be sent to the cloud server for further processing (along with the ID of the underlying content at the time of scroll), reducing the data that must be sent relative to the raw data 500 but still encapsulating more granular information for analysis than is typically provided.

FIG. 6 illustrates a series 600 of x/y coordinates along a U-shape generated by a scroll from left to right and back again as indicated by the arrow 602. The raw data 600 is condensed at the device on which the scroll was input into two vectors the length of which indicates the speed of scroll and the direction of which indicates the direction of scroll, along with start of scroll information including time and underlying content, turn information including the degree of scroll reversal (in the example shown, one hundred eighty degrees) and time along with underlying content at the turn, and return dwell information including time the scroll ended and the period from then until a new touch is received, along with the concurrent underlying content which can be presumed to be of interest to the user since the user scrolled past it and then returned to it. Only this condensed version 602 of the raw data 600 need be sent to the cloud server for further processing.

FIG. 7 illustrates raw touch data 700 indicating acceleration of scroll from right to left as represented by the increasing distance between x/y coordinates. This raw data may be condensed into a vector indicating direction and speed and a start time 702 of the acceleration along with underlying content ID, inferentially content that was not interesting to the user since the user accelerated scrolling through it. The time the scroll acceleration stopped or slowed also may be part of the condensed data sent to the cloud along with the ID of the concurrently displayed content, which may be inferred to be of interest to the user since the user slowed or stopped scrolling upon encountering this content.

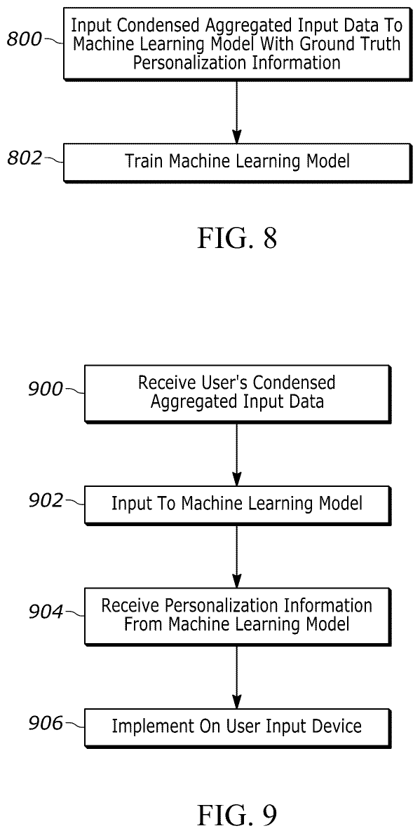

Now refer to FIG. 8. At state 800 condensed aggregated input data such as any of the condensed data examples discussed herein is input to a ML model such as the ML model 214 shown in FIG. 2 along with ground truth personalization information to train the model at state 802. Personalization information may include indications of content that is inferred to be interesting or uninteresting based on scrolling patterns as judged, for example, by human experts. Other personalization apart from preferred/non-preferred content may include font size associated with the content, color associated with the content, images associated with the content, game personalization settings, etc.

Subsequent to training, at state 900 of FIG. 9, as a cloud server (such as the cloud server 210 shown in FIG. 2) receives condensed aggregated input (such as scrolling) data from a user input device (such as the controller 200 shown in FIG. 2) at state 900, the cloud server may input the data to the ML model at state 902. Moving to state 904, personalization information is received form the ML model, which is sent to the originating user device at state 906 for implementation on the user device.

Note that analysis of condensed aggregated data from an input device may be executed on an analysis device other than the cloud server, for example, on the console 206 shown in FIG. 2.

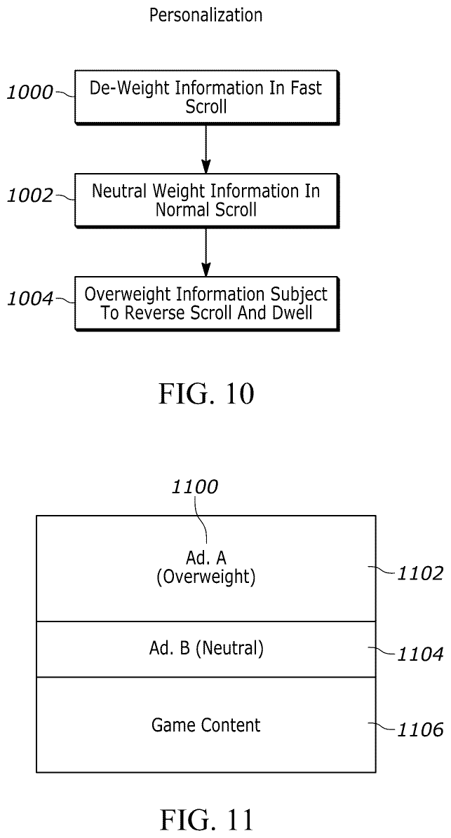

FIG. 10 illustrates personalization logic that may be implemented with or without ML. At state 1000, information or content that was being presented at the time of a relatively fast scroll input operation may be de-weighted so that such information or content is not presented on the originating input device or is presented relatively unobtrusively. State 1002 indicates that for information presented concurrently with a normal scroll speed, a neutral weight may be applied, whereas state 1004 indicates that information that appeared during a dwell period of the user after a reverse scroll may be overweighted. Such overweighted information or content may be prominently presented on the originating user input device as an example of personalization.

FIG. 11 illustrates further. An overweighted advertisement 1100 from FIG. 10 is prominently presented on almost half of a display 1102 associated with an originating user input device. For example, the display 1102 in FIG. 1 may be the display 216 shown in FIG. 2 when the originating input device is the controller 200.

On the other hand, content 1104 with a neutral weight may be displayed but less obtrusively than the overweighted content 1100. Game content 1106 may be presented as well.

Because of variations in touch speed and friction between different input devices, the type of input device sending the condensed aggregated data for further analysis may be reported to the analysis device, e.g., the cloud server. In this way, scroll speed, for example, can be normalized by the analysis device prior to using it for personalization.

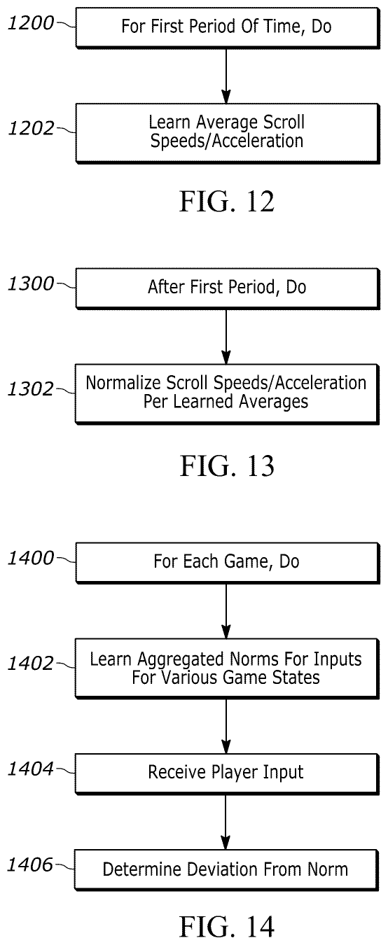

Alternatively, FIG. 12 illustrates that at state 1200, for an initial period the average scroll speeds and acceleration of scroll and/or other input parameters may be learned at state 1202. Subsequently, at state 1300 in FIG. 13 logic may flow to state 1302 to normalize speeds and acceleration if scroll or other input according to the learned averages from FIG. 12.

FIG. 14 illustrates additional logic for computer game use cases. Commencing at state 1400, for each game the logic may flow to state 1402 to learn aggregated norms for inputs in various game states, including norms for scroll speed and acceleration, norms for speed and frequency of button pushes, etc. Subsequently, individual player input may be received at state 1404 and any deviations of the input from state 1404 with respect to the aggregated norms from state 1402 are determined at state 1406. Any such deviations may indicate hardware failure, fatigued user, and other player identities who might be good teammates for the player under test based on the characteristic deviations of the player from state 1406.

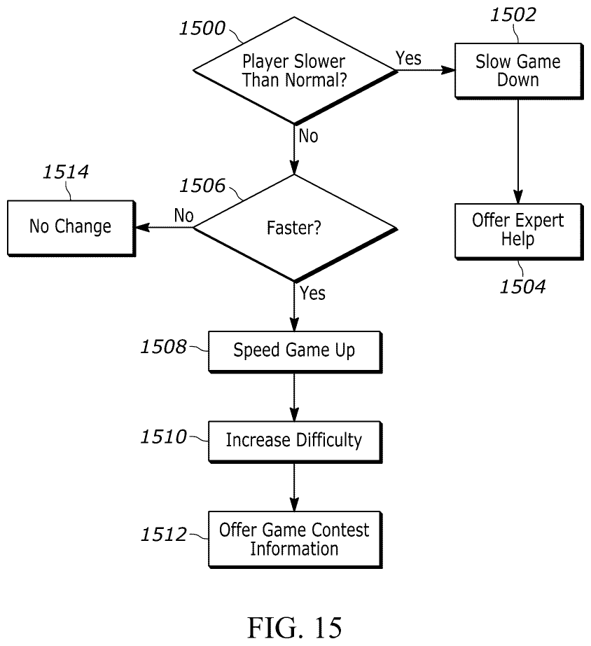

FIG. 15 illustrates further uses of determined deviations from FIG. 14 for personalization purposes. If it is determined at state 1500 that the player is inputting control signals more slowly than the norm for the particular game being played, the game may be slowed down in audio-video presentation at state 1502 and/or game difficulty level reduced. Expert help may be offered to the player at state 1504.

However, if it is determined at state 1506 that the player is able to input control signals faster than the norm for the game, the game may be sped up at state 1508 and/or difficulty level increased at state 1510. Game contest information may be offered to the player at state 1512. State 1514 indicates that no changes may be made responsive to determining that the player is inputting signals per the norm for the game.

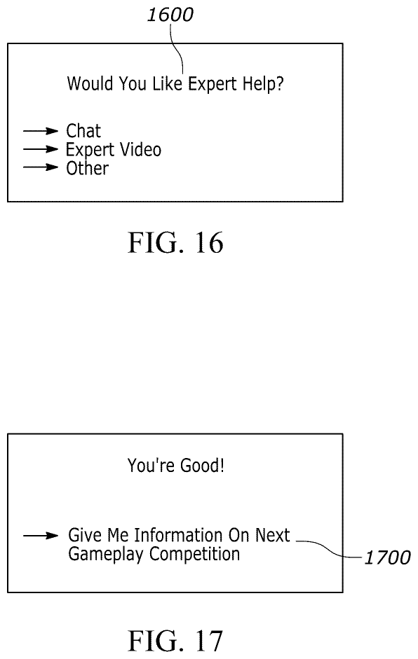

FIG. 16 illustrates a screen shot that may be presented on any display described herein consistent with state 1504 in FIG. 15. A query 1600 may be presented as to whether the player would like expert help. In the example shown, the player may elect to receive help via chat, or by watching an expert play the game, or other means.

FIG. 17 illustrates a screen shot that may be presented on any display described herein consistent with state 1512 in FIG. 15. A selector 1700 may be presented to allow the player to obtain information on upcoming game tournaments.

While the particular embodiments are herein shown and described in detail, it is to be understood that the subject matter which is encompassed by the present invention is limited only by the claims.

What is claimed is:

1. A method comprising:
receiving raw data from touch input on a touch surface of a device;
at the device, condensing the raw data to condensed data;
sending the condensed data to an analysis apparatus;
at the analysis apparatus, using the condensed data to identify personalization information;
sending the personalization information to the device; and
implementing at least some of the personalization information on the device.

2. The method of claim 1, wherein the raw data is from a scroll motion on the touch surface.

3. The method of claim 2, wherein the condensed data comprises at least one vector indicating direction and speed of the scroll motion.

4. The method of claim 1, wherein the condensed data comprises at least an identification of content being presented concurrently with receiving the raw data from the touch surface.

5. The method of claim 1, wherein the device comprises a computer game controller.

6. The method of claim 1, wherein the device comprises a wireless telephone.

7. The method of claim 1, wherein the analysis apparatus comprises a cloud server.

8. The method of claim 1, comprising:
inputting the condensed data to at least one machine learning (ML) model; and
receiving the personalization information from the ML model.

9. The method of claim 1, wherein the raw data comprises a series of x/y coordinates.

10. A processor system configured to:
receive signals from a touch surface of a device;
condense the signals to vectors;
send the vectors to an analysis apparatus;
receive from the analysis apparatus personalization information related to the vectors; and
implement the personalization information on the device.

11. The processor system of claim 10, wherein the signals are generated by a scroll motion on the touch surface.

12. The processor system of claim 11, wherein the vectors indicate direction and speed of the scroll motion.

13. The processor system of claim 10, wherein the vectors are sent with at least an identification of content being presented concurrently with receiving the signals from the touch surface.

14. The processor system of claim 10, wherein the device comprises a computer game controller.

15. The processor system of claim 10, wherein the device comprises a wireless telephone.

16. The processor system of claim 10, wherein the analysis apparatus comprises a cloud server.

17. The processor system of claim 10, wherein the signals from the touch surface comprise a series of x/y coordinates.

18. An apparatus comprising:
at least one computer memory that is not a transitory signal and that includes instructions executable by at least one processor system to:
receive condensed data from a device, the condensed data representing raw data generated by a scroll motion on a touch surface of the device;
correlate the condensed data to personalization information; and
transmit the personalization information to the device.

19. The apparatus of claim 18, wherein the instructions are executable to:
input the condensed data to at least one machine learning (ML) model; and
receive the personalization information from the ML model.

20. The apparatus of claim 18, wherein the condensed data comprises vectors and the raw data comprises a series of x/y coordinates.
